(19) United States
(12) Patent Application Publication
(10) Pub. No.: US 2012/0012237 A1
(43) Pub. Date: Jan. 19, 2012

(54) Tubeless Tire having a Slitted Inner-Liner, and Process for its Manufacture

(75) Inventors: Sebastien Beaugrand, Lempdes (FR); Daniel Lesclingant, St-Bonnet-Pres-Riom (FR); Gilles Pommeyrol, Pont du Chateau (FR)

(73) Assignees: Michelin Recherche et Technique S.A., Granges-Paccot (CH); SOCIETE DE TECHNOLOGIE MICHELIN, Clermont-Ferrand (FR)

(21) Appl. No.: 13/059,055

(22) PCT Filed: Aug. 6, 2009
(86) PCT No.: PCT/EP2009/060229

§ 371 Date: Sep. 21, 2011

Related U.S. Application Data
(60) Provisional application No. 61/110,764, filed on Nov. 3, 2008.

(30) Foreign Application Priority Data
Aug. 14, 2008 (FR) 0855584

(51) Int. Cl. B60C 5/14; B29D 30/10

(52) U.S. Cl. 152/510; 156/117

(57) ABSTRACT

Tubeless tire, adapted to be inflated with an inflation gas, comprising: a crown (25) comprising a crown reinforcement (80, 90) surmounted by a tread (40); two sidewalls (30) extending the crown radially inwards; two beads (20) radially inside the sidewalls and each comprising a annular reinforcement structure (70); a carcass reinforcement (60) anchored in each of the beads; an inner-liner (50) impermeable to the inflation gas, covering the inner surface of the tire; wherein, in each sidewall of the tire, the inner-liner comprises at least one slit (200), situated radially between the annular reinforcement structure that is radially outermost, and the radius RE at which the carcass reinforcement, when the tire is fitted to the rim and inflated to its operating pressure, has its largest axial width, the slit having a maximum radial height HR of between 0.5 and 5 mm and extending over at least half of the circumference of the tire. Also disclosed is a process for manufacturing such a tire.

### RELATED APPLICATIONS

This is a U.S. National Phase Application under 35 USC 371 of International Application PCT/EP2009/060229, filed on Aug. 6, 2009.

This application claims the priority of French patent application no. 08/55584 filed Aug. 14, 2008 and U.S. provisional patent application No. 61/110,764 filed Nov. 3, 2008, the entire contents of both of which are hereby incorporated by reference.

### FIELD OF THE INVENTION

The present invention relates to tubeless tires, and more particularly the inner-liners that are gastight to the gas for inflating these tires. It also relates to a process of manufacturing these tires.

### BACKGROUND OF THE INVENTION

Most tubeless tires designed to be inflated with an inflation gas comprise an “inner-liner”, that is to say a rubber compound that is impermeable to the inflation gas, covering the inner surface of the tire. This inner-liner is most often formed by a butyl-based rubber compound.

The fact that these inner-liners are impermeable to the inflation gas may give rise to problems in tire manufacture. In particular it has been observed that the air trapped during the making of the tire may accumulate beneath the inner-liner, in particular at the bead and the radially inner half of the sidewall, so as to form bubbles therein. These bubbles spoil the appearance of the tire, but their presence may also have consequences on the longevity of the tire. Specifically, the bubbles may initiate a loss of adhesion of the inner-liner. In serious cases, the inner-liner may detach from the beads and from the inner portion of the sidewall, which causes a certain loss of seal and the penetration of a considerable quantity of air into the materials forming the tire, which may reduce the lifetime of the tire. The loss of adhesion would also be a factor to cause the client to replace the tire. This is why tire manufacturers examine the tires after curing in order to detect the presence of bubbles. If the number and/or the size of the bubbles are too great, the tires are destroyed.

Several solutions have been proposed to overcome this difficulty. As an example, document JP 60196331 proposes to burn holes in the inner-liner with the aid of a laser beam. These holes allow the air to escape during the making of the tire and the first stages of vulcanization. They close by the inner-liner flowing during vulcanization, which makes it possible to have an intact inner-liner after curing.

Document JP 2005238654 describes another approach using an inner-liner with holes in it and an appropriate mould.

Another solution to the problem of the formation of bubbles consists in reducing the surface area covered by the inner-liner. In particular it is possible for the bead and the radially innermost portion of the sidewall not to be covered with inner-liner. Tires of this type have been developed for the purpose of lightening the tire, but they also have the advantage of being less affected by the formation of air bubbles. Such tires are known, for example, from documents JP 4090902 and EP 1 228 900.

Such tires nevertheless have disadvantages. In particular it has been noted that the reduction in the surface area covered by the inner-liner causes an increase in noise generated by the tire, in particular in the cavity mode frequency domain. The use of such tires therefore increases the body vibrations of the vehicle to which the tires are fitted and reduces the acoustic comfort of the user. Moreover, the reduction in the surface area covered by the inner-liner leads to greater losses of inflation pressure over time.

### SUMMARY OF THE INVENTION

One objective of the present invention is to provide tubeless tires the manufacture of which is less prone to the formation of air bubbles between the inner-liner and the adjacent portions of the tire and that consequently have a better longevity, while allowing to minimise losses of inflation pressure.

This objective is achieved in accordance with one aspect of the preset invention by a tubeless tire, designed to be inflated with an inflation gas, comprising:
a crown comprising a crown reinforcement surmounted by a tread;
two sidewalls extending the crown radially inwards;
two beads radially inside the sidewalls and each comprising at least one annular reinforcement structure;
a carcass reinforcement anchored in each of the beads;
an inner-liner impermeable to the inflation gas, covering the inner surface of the tire.

In each sidewall of a tire according to an embodiment of the invention, the inner-liner comprises at least one slit situated radially between:
the annular reinforcement structure that is radially outermost, and
the radius at which the carcass reinforcement, when the tire is fitted to the rim and inflated to its operating pressure, has its largest axial width.

The slit has a maximum radial height of between 0.5 and 5 mm, preferably between 1.5 and 2.5 mm, and extends over at least half (180°) of the circumference of the tire.

It has been noted that such a tire very significantly reduces the formation of bubbles during its manufacture, because the air accumulated between the inner-liner and the adjacent portions of the tire escapes through the slit provided in the inner-liner. The loss of inflation pressure is significantly reduced compared to tires having a reduced surface area covered by the inner-liner. In addition, noise measurements have made it possible to ascertain that a tire according to the invention generates less noise than an equivalent tire with an inner-liner that does not cover the bead and the radially inner portion of the sidewall.

According to a preferred embodiment, the slit extends over at least three quarters of the circumference of the tire (in other words, over 270°). Such a slit makes it possible to drain the air over virtually the whole of the circumference. The diffusion path of the rest of the occluded air is sufficiently short to allow the air to be drained in a short time (typically of the order of a few minutes). A single slit may therefore be sufficient to drain all of the occluded air.

Yet more preferably, the slit extends over the whole circumference of the tire so that all the occluded air is easily drained, without making use of diffusion, in a circumferential direction, of this air towards a slit, which is not instantaneous.

According to a particular embodiment, the radial height of the slit tends towards zero at its ends: so the slit is crescent-shaped.

According to a preferred embodiment, the slit is continuous. Specifically, if the slit is uninterrupted, its capacity to drain air is maximized.

According to an alternative embodiment, the slit includes an alignment of holes in the inner-liner. This embodiment may be advantageous particularly when it is desired to provide a slit which extends over the whole circumference of the tire. If the slit is continuous, it is then necessary, during the making, to handle three portions of inner-liner. If the slit consists of an alignment of holes (including small slits), that is to say if the inner-liner is only perforated, it may be placed in a single piece, which makes its handling easier.

Another aspect of the invention is directed to a process of manufacturing a tire, comprising a step of producing the inner-liner of the tire by placing a strip of rubber compound that is gastight to the gas intended for the inflation of the tire, on a rigid core rotated about an axis at an angular speed ψ. The strip of width L is placed on the rigid core with the aid of a strip-placement tool, this placement tool being moved during the placement operation in a direction substantially perpendicular to the axis of rotation of the rigid core, at a speed of movement V. The angular speed ω and the speed of movement V are chosen such that a portion of the strip placed at the end of a revolution of the rigid core comes into contact with, but does not overlap a portion of the strip placed at the start of the same revolution of the rigid core, or the contact therebetween also involves an overlap.

This is notably the case if:

$${\int }_{0}^{T} V ( t ) \cdot d t \leq L \qquad ( 1 )$$

where T is the time the rigid core takes to make a complete revolution. The equality option of this relationship will produce contact without overlap, whereas the inequality option will produce contact with overlap. Two portions are said to overlap if a part of one portion is superposed on a part of the other portion, in a direction perpendicular to the surface on which the portions are placed.

During the placement of the portion of inner-liner situated radially between:
the radial position in which, after completion of the tire manufacturing process, the radially outermost annular reinforcement structure will be situated, and
the radial height at which the carcass reinforcement, when the tire, after completion of the tire manufacturing process, is mounted on the rim and inflated to its working pressure, will have its largest axial width,
the speed of movement of the strip-placement tool and/or the speed of rotation of the rigid core are momentarily, that is to say for a certain time, modified in order to satisfy the inequality

$${\int }_{0}^{T} V ( t ) \cdot d t > L \qquad ( 2 )$$

so that a portion of the rigid core is not covered by the strip.

This produces a tire comprising a crescent-shaped continuous slit. An advantage of this process is that it makes it possible to obtain a tire by a simple modification of the existing processes, without the need to handle slitted or perforated inner-liner plies.

### BRIEF DESCRIPTION OF THE DRAWINGS

FIG. 1 represents schematically a tire according to the prior art.

FIG. 2 represents schematically a partial view in perspective of a tire according to the prior art.

FIG. 3 represents schematically a radial section of a portion of a tire according to the prior art.

FIGS. 4 and 5 illustrate schematically a recurrent problem in the manufacture of tires according to the prior art.

FIGS. 6 to 8 illustrate schematically the loss of adhesion of the inner-liner due to the presence of an air bubble under the inner-liner.

FIG. 9 represents schematically a radial section of a portion of a tire making it possible to overcome the problem of bubble-formation between the inner-liner and the adjacent portions of the tire in the region of the bead.

FIG. 10 represents schematically a radial section of a portion of a tire according to an embodiment of the invention.

FIGS. 11 to 15 illustrate schematically possible slit geometries.

FIGS. 16A to 21C illustrate schematically a first embodiment of the process according to the invention.

FIGS. 22 to 24 illustrate schematically a second embodiment of the process according to the invention.

FIGS. 25 to 26 illustrate schematically the radial movement of the placement tool in the first and second embodiments of the process according to the invention.

### DETAILED DESCRIPTION OF THE DRAWINGS

It is appropriate to distinguish between several different uses of the word “radial” by those skilled in the art. First, the expression refers to a radius of the tire. It is in this sense that it is said of a point A that it is “radially internal” to a point B (or “radially inside” the point B) if it is closer to the axis of rotation of the tire than point B. Conversely, a point C is said to be “radially external to” a point E (or “radially outside” the point E) if it is further away from the axis of rotation of the tire than the point E. It will be said that there is movement “radially inwards (or outwards)” when there is movement in the direction of the smaller (or larger) radii. When radial distances are referred to, this sense of the term also applies.

In contrast, a thread or a reinforcement is called “radial” when the thread or the reinforcing elements of the reinforcement make an angle that is greater than or equal to 65° and less than or equal to 90° with the circumferential direction. It should be specified that, in the present document, the word “thread” must be understood in a completely general sense and includes the threads that are in the form of monofilaments, multifilaments, a cable, a folded yarn or an equivalent assembly, and this is so irrespective of the material forming the thread or the coating that is applied in order to promote its adhesion with the rubber.

Finally, “radial section” in this instance means a section along a plane that contains the axis of rotation of the tire.

An “axial” direction is a direction parallel to the axis of rotation of the tire. A point E is called “axially internal” to a point F (or “axially inside” the point F) if it is closer to the mid-plane of the tire than the point F. Conversely, a point G is called “axially external to” a point H (or “axially outside” the point H) if it is further away from the mid-plane of the tire than the point H. The “mid-plane” of the tire is the plane that is at right angles to the axis of rotation of the tire and that is equidistant from the annular reinforcement structures of each bead.

A “circumferential” direction is a direction that is perpendicular to both the radius of the tire and the axial direction.

Two reinforcement elements are said to be “parallel” in this document when the angle formed between the two elements is less than or equal to 20°.

In the context of this document, the expression “rubber compound” is a compound comprising at least one elastomer and one filler.

A “tread” for a tire is intended to mean a quantity of rubber compound, delimited by two main surfaces of which one is intended to come into contact with the ground when the tire rolls, and by lateral surfaces.

When it is said that the inner-liner has a “slit” or a “hole”, this does not signify that there must be a groove or a recess on the inner surface of the tire after curing. It is possible that the slit or the hole of the inner-liner is filled with a rubber compound that is not impermeable to the inflation gas, which may be due notably to the flow of the rubber compound forming the portions of the tire adjacent to the inner-liner, during curing of the tire. What is important is that there are still slit-shaped or hole-shaped zones where the rubber covering the inner surface of the tire is not impermeable to the inflation gas.

“Inner surface of the tire” in this instance means the surface of the tire that is intended to be in contact with the inflation gas when the tire is fitted to the rim and inflated.

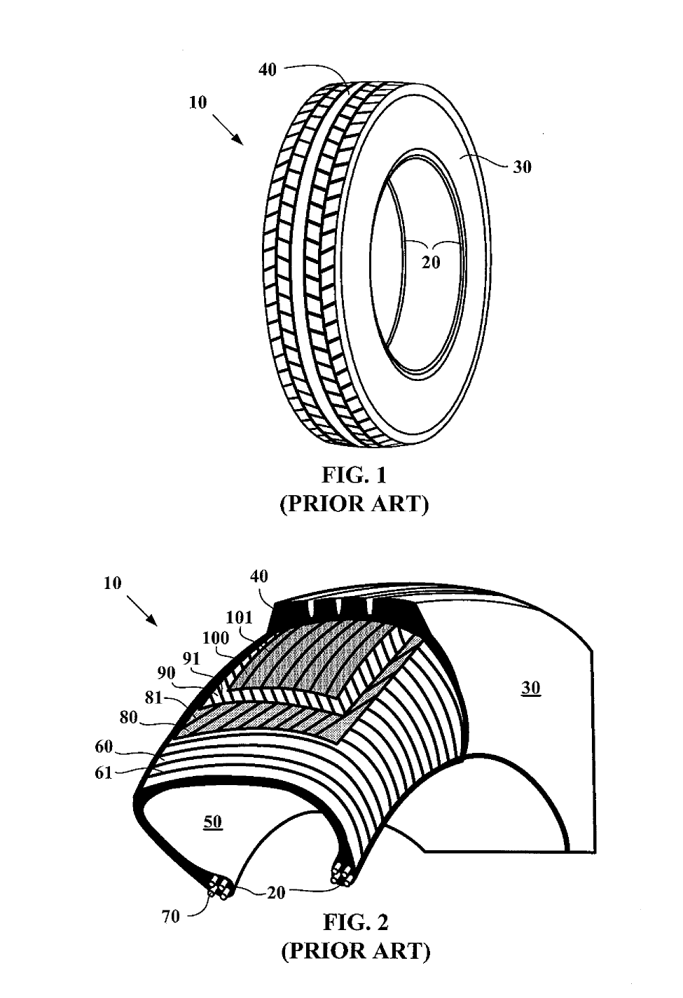

FIG. 1 represents schematically a tubeless tire 10 according to the prior art. The tire 10 comprises a crown including a crown reinforcement (invisible in FIG. 1) surmounted by a tread 40, two sidewalls 30 extending the crown radially inwards, and two beads 20 radially inside the sidewalls 30.

FIG. 2 represents a partial view in perspective of a different tubeless tire 10 according to the prior art and illustrates the various components of the tire. The tire 10 comprises an “inner-liner” 50 made of a rubber compound impermeable to the inflation gas, covering the inner surface of the tire 10, a carcass reinforcement 60 made of threads 61 coated with a rubber compound, and two beads 20 each comprising annular reinforcement structures 70 that hold the tire 10 on the rim (not shown). The carcass reinforcement 60 is anchored in each of the beads 20. The tire 10 also comprises a crown reinforcement comprising two plies 80 and 90. Each of the plies 80 and 90 is reinforced by thread reinforcing elements 81 and 91 that are parallel in each layer and crossed from one layer to the other, making angles of between 10° and 70° with the circumferential direction. The tire also comprises a hooping reinforcement 100, positioned radially outside the crown reinforcement, this hooping reinforcement being formed of reinforcement elements 101 oriented circumferentially and spiral-wound. A tread 40 is placed on the hooping reinforcement; it is this tread 40 which makes the contact of the tire 10 with the road.

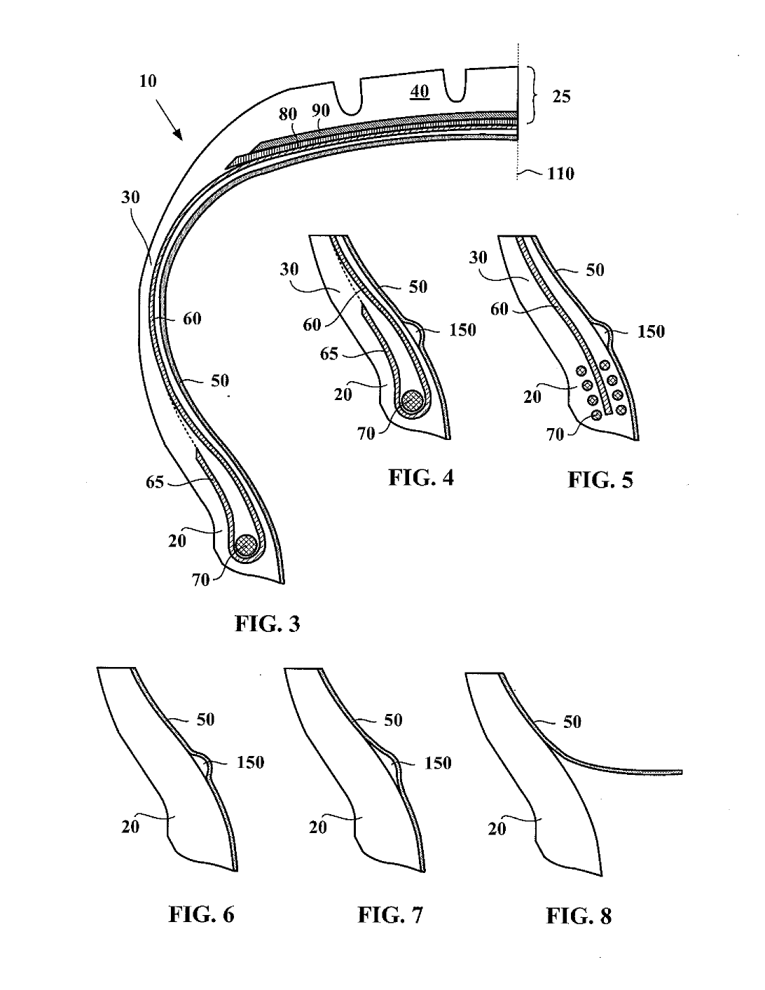

FIG. 3 represents schematically, in radial section, a quarter of a tire 10 according to the prior art. The tire 10 comprises a crown 25 with a crown reinforcement formed of a first layer of reinforcements 80 and a second layer of reinforcements 90, and surmounted radially by a tread 40. Each layer of reinforcements comprises thread reinforcements, coated with a matrix formed of rubber compound. The reinforcements of each layer of reinforcements are substantially parallel with one another; the reinforcements of the two layers are crossed from one layer to the other at an angle of approximately 20°, as is well known to those skilled in the art for so-called radial tires. The tire 10 also comprises sidewalls 30 and two beads 20 each of which comprises an annular reinforcement structure 70, in this instance bead wires. The tire 10 also comprises a carcass reinforcement 60 which extends from one bead 20 to the other and which is anchored in each of the two beads 20 by a turn-up 65. This carcass reinforcement 60 in this instance comprises thread reinforcements oriented substantially radially, that is to say making an angle greater than or equal to 65° and less than or equal to 90° with the circumferential direction. The inner surface of the tire is covered with an inner-liner 50. The mid-plane of the tire 10 bears the reference number 110.

The fact that these inner-liners are impermeable to the inflation gas may give rise to problems in tire manufacture. In particular it has been observed that the air trapped during the making of the tire may accumulate beneath the inner-liner, particularly at the bead and the radially inner half of the sidewall, and form bubbles therein. FIG. 4 illustrates this recurrent problem in the manufacture of tires according to the prior art. The lower portion of the sidewall 30 and the bead 20 of the tire 10 of FIG. 3 are shown. In the portion shown, an air bubble 150 has formed between the inner-liner 50 and the adjacent portions of the bead and the sidewall.

The presence of such bubbles when the tire comes out of its curing mould is in no way limited to tire architectures such as that represented in FIG. 3. It is also possible to find such bubbles in tires in which the carcass reinforcement 60 is not anchored in the bead 20 by a turn-up 65, but held by a plurality of annular reinforcement structures 70 as shown in FIG. 5. Below, only tires having a turn-up of the carcass reinforcement 60 are shown, but this is in no way a limiting feature of the invention. Each bead 20 has an outermost annular reinforcement structure 70. When bead 20 has a plurality of such structures 70 (as in FIGS. 2 and 5), the outermost one is that which is furthest away from the axis of rotation of the tire. When bead 20 has only a single structure 70, the term “outermost annular reinforcement structure” applies to it.

The air bubbles 150 spoil the visual appearance that the tire presents to the user before fitting, but their presence may also have consequences on longevity. Specifically, the bubbles may serve as an initiation for the loss of adhesion of the inner-liner. This disadvantage is illustrated in FIGS. 6 to 8. FIG. 6 shows the initial state of the tire. Gradually as the tire is used, which means cycles of mechanical stress and heating, the inner-liner 50 separates from the adjacent portions of the tire in the vicinity of the bubble 150. The latter therefore changes shape and surface area (FIG. 7). In serious cases, the inner-liner 50 may detach from the beads 20 and from the inner portion of the sidewall, as shown in FIG. 8. This detachment causes a certain loss of seal and the penetration of a considerable quantity of air into the materials forming the tire. The loss of adhesion would also be a factor to cause the client to replace the tire.

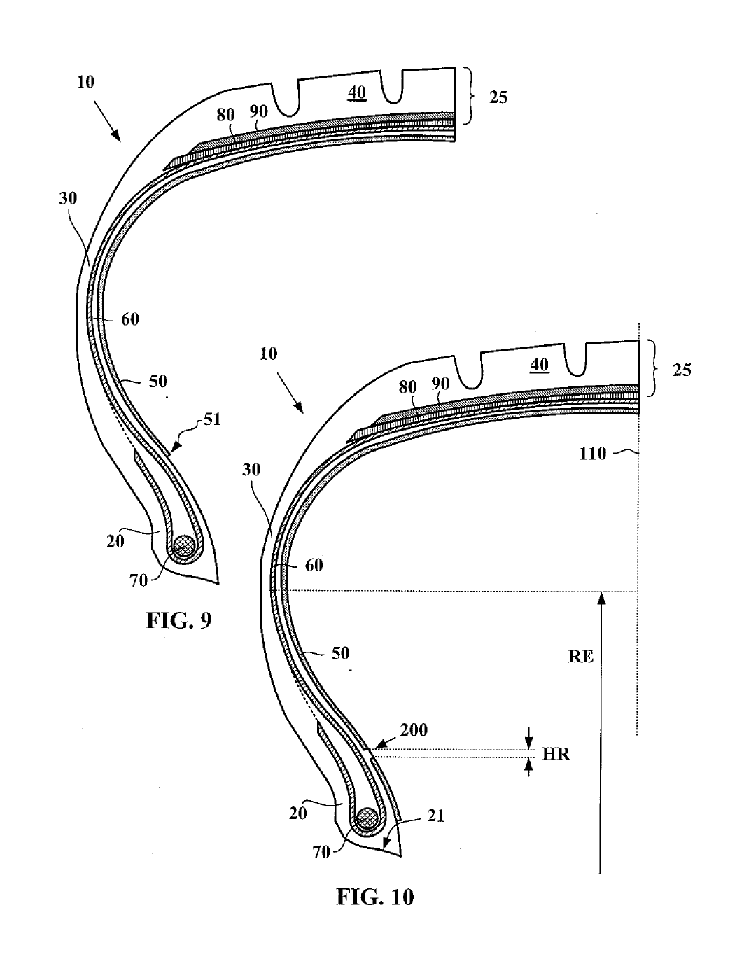

A solution to the problem of the formation of bubbles includes reducing the surface area covered by the inner-liner, as shown in FIG. 9. The tire 10 comprises an inner-liner 50 having its radially inner end 51 located radially outside the bead 20. Inner-liners of this type are notably known from documents JP 4090902 and EP 1 228 900. Naturally, since the inner-liner does not cover a considerable bubble-formation zone and therefore does not trap the air likely to form bubbles, the risk of bubble formation is greatly reduced.

Such tires nevertheless have disadvantages. In particular it has been noted that the reduction in the surface area covered by the inner-liner causes an increase in noise generated by the tire, in particular in the cavity mode frequency domain. The use of such tires therefore increases the body vibrations of the vehicle to which the tires are fitted and reduces the acoustic comfort of the user. Moreover, the reduction in the surface area covered by the inner-liner leads to greater losses of inflation pressure over time.

This disadvantage is overcome by a tire according to an embodiment of the invention, such as the tire 10 shown in FIG. 10. The only difference relative to the tire of FIG. 9 is that the inner-liner 50 extends to the radial height of the annular reinforcement structure 70 and comprises, in each sidewall of the tire, a slit 200, situated radially between the annular reinforcement structure 70 and the radius RE (measured from the axis of rotation of the tire, which is not represented) at which the carcass reinforcement 60 when the tire 10 is fitted to its rim (not shown) and inflated to its working pressure, has its largest axial width. The maximum radial height HR of the slit in this embodiment is 2.5 mm. In this instance, the slit 200 is filled with a quantity of rubber compound having flowed from the adjacent portions of the tire.

It should be noted that there may be a little flow of the inner-liner during the curing of the tire, which has the effect of reducing the radial height of the slit. In order to obtain a slit of a radial height HR in the cured state, it may be necessary, depending on the materials used, to provide a slit that is slightly larger in the raw state.

It has been found that providing an inner-liner 50 that terminates only at the height of the annular reinforcement structure 70, or which even extends to the seat 21 of the bead, but is interrupted by the slit 200 significantly reduces the problems associated with the air occluded between the inner-liner 50 and the adjacent portions of the tire. Moreover, this result is accomplished without increasing the noise emitted by the tire when rolling. This advantage can be explained by the fact that inner-liner 50 is quite hysteretic, whereas the underlying rubber material of the tire is less so.

Moreover, the static loss of inflation pressure at 20° C. is significantly reduced compared to tires having a reduced surface area covered by the inner-liner. Measurements were carried out on tires having the general structure of the tire of FIG. 3. A tire having an inner-liner such as the one in FIG. 3 lost 40 mbar of its inflation pressure over a period of four weeks (static conditions, 20° C.) For the same tire without any inner-liner, the losses amounted to 65 mbar. A tire having a shortened inner-liner (such as the one shown in FIG. 9) lost 50 mbar, whereas in a tire according to the invention (FIG. 10) the losses were reduced to 45 mbar.

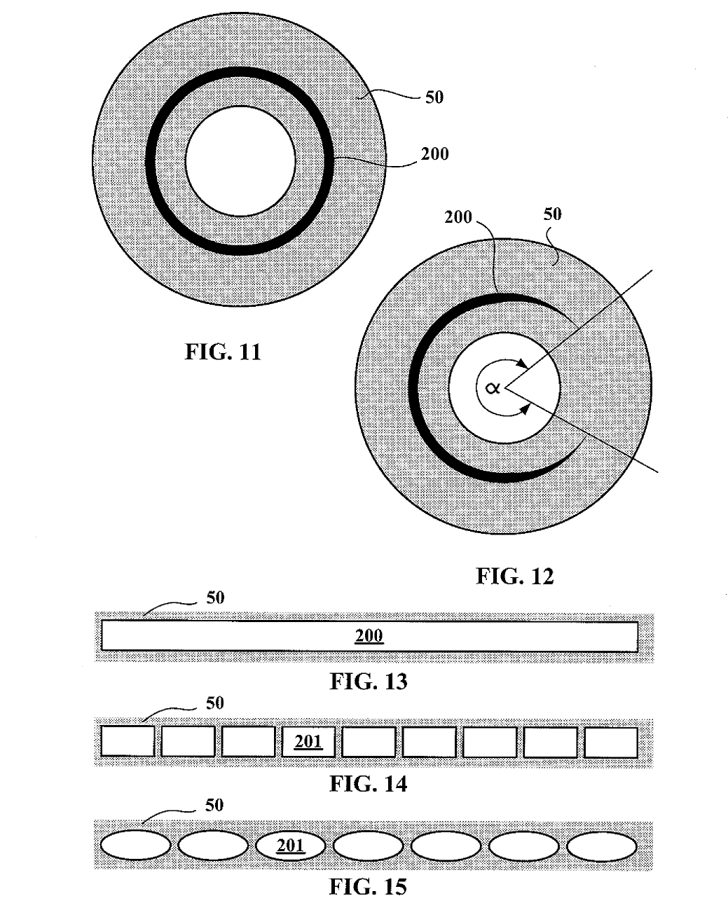

FIGS. 11 and 12 illustrate schematically certain geometries of possible slits. The view corresponds to a view in circumferential section (in a plane perpendicular to the axis of rotation of the tire); it shows the inner surface of a sidewall, covered with inner-liner 50 comprising a slit 200.

The slit 200 of FIG. 11 has a constant radial height HR of 3 mm and extends over the whole circumference of the tire. Therefore, all the occluded air is easily drained, without making use of diffusion, in a circumferential direction, of this air towards a slit.

By way of contrast, the slit 200 of the tire of FIG. 12 does not extend over the whole circumference of the tire, but only over slightly more than three quarters of the circumference of the tire (α=295°). The radial height of the slit has a maximum value HR of 3 mm and tends towards zero at its ends: so the slit has a crescent shape. Such a slit makes it possible to drain the air over virtually the whole circumference. The diffusion path of the rest of the occluded air is sufficiently short to allow drainage in a short time. This type of slit may easily be manufactured with the process according to an embodiment of the invention which will be described below.

The concept of “slit”, as used in this document, does not only cover a simple continuous slit, such as the slits 200 represented in FIGS. 11 and 12. It includes slits having an alignment of holes (or of small slits) in the inner-liner. This is illustrated in FIGS. 13 to 15.

FIG. 13 represents a portion of a continuous slit 200, like the slits 200 represented in FIGS. 11 and 12. Abstraction has been made of the curvature of the tire. Such a slit has a maximized capacity to drain air.

FIGS. 14 and 15 each represent a slit including an alignment of holes 201. This process may be advantageous particularly when the slit extends over the whole circumference of the tire. If the slit is continuous, it is then necessary, during the making, to handle three portions of inner-liner. If the inner-liner is perforated, it may be placed in a single piece, which makes its handling easier.

Those skilled in the art understand that it is easy to obtain a tire according to the invention by using a ply of airtight rubber compound which is perforated in advance, or by simply assembling several portions of inner-liner with a conventional manufacturing process on a drum. In principle, it would also be possible to cut a slit after the tire is made. These processes however have the disadvantage of being cumbersome. In addition, a cutting operation on the cured tire comprises the danger of damaging the tire. The process according to an embodiment of the invention makes it possible to dispense with these difficulties.

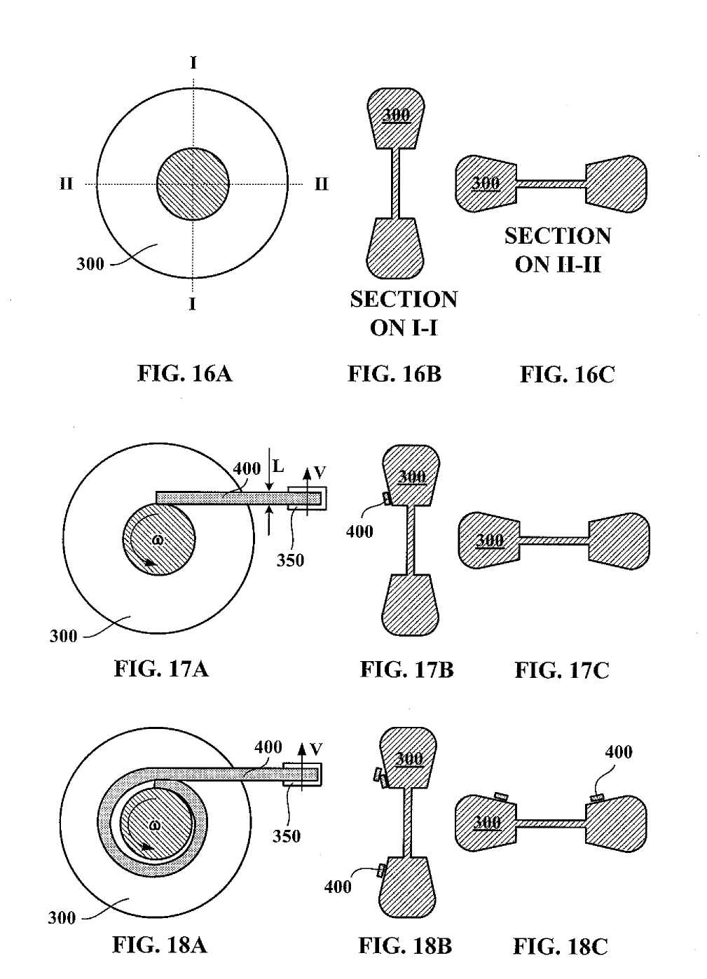

A first embodiment of the process according to the invention is illustrated with the aid of FIGS. 16A to 21C. Only the essential steps of the process will be described here. Processes including the placement of strips on a rigid core are well known to those skilled in the art. One example among others is given in document EP 0 666 165, which is hereby incorporated herein by reference. The “C3M” process, of which a brief description is presented in the booklet “The tire Digest” published by Michelin in 2002, corresponds to such a process.

FIG. 16A represents schematically a rigid core 300 that may be rotated about an axis of rotation at an angular speed ψ. FIGS. 16B and 16C represent the same rigid core in a section along I-I and in a section along II-II (see FIG. 16A), respectively. In the subsequent figures, the portions B and C (e.g. 17B and 17C) still correspond to sections along I-I and II-II, respectively.

FIG. 17A shows the first step of a process according to an embodiment of the invention. A strip 400 (width L) of rubber compound impermeable to the gas intended for the inflation of the tire is supplied by a supply means 350 and applied to the rigid core 300 by the placement tool known per se (which has not been shown, for the sake of clarity). Then, the rigid core 300 is set in rotation at a substantially constant angular speed ψ. According to the first embodiment of the process according to the invention, the placement tool advances at a substantially constant initial speed V₀ in a direction substantially perpendicular to the axis of rotation of the rigid core. The placement tool can be one such as is disclosed in U.S. 2007/0199661, the content of which is hereby incorporated herein by reference.

If the time that the rigid core 300 takes to make one revolution about its axis of rotation is T, one may write

$$T = \frac{2 π}{ω} \qquad ( 3 )$$

In order for the portion of strip that will be placed after one revolution of the rigid core to overlap a part of the portion of strip placed during this revolution, the placement tool must be advanced by a distance D that is less than the width L of the strip in the direction perpendicular to the axis of rotation of the rigid core. In mathematical terms, this corresponds to the following inequality:

$$D = {\int }_{0}^{T} {V}_{0} \cdot d t = {V}_{0} \cdot T < L \qquad ( 4 )$$

If the expression (3) is inserted, it is possible to rewrite this inequality as follows:

$$2 π \cdot \frac{{V}_{0}}{ω} < L \qquad ( 5 )$$

This condition may be satisfied by an appropriate choice of V₀ and ψ.

FIG. 18A shows the result obtained after one revolution of the rigid core 300, when the condition (5) is satisfied: there is overlap of the portion of strip 400 placed on the first revolution and the portion of strip that will be added on the second revolution. If the operator continues in these conditions, it is possible to place the whole inner-liner without having the slightest slit on the bead and on the sidewall of the tire.

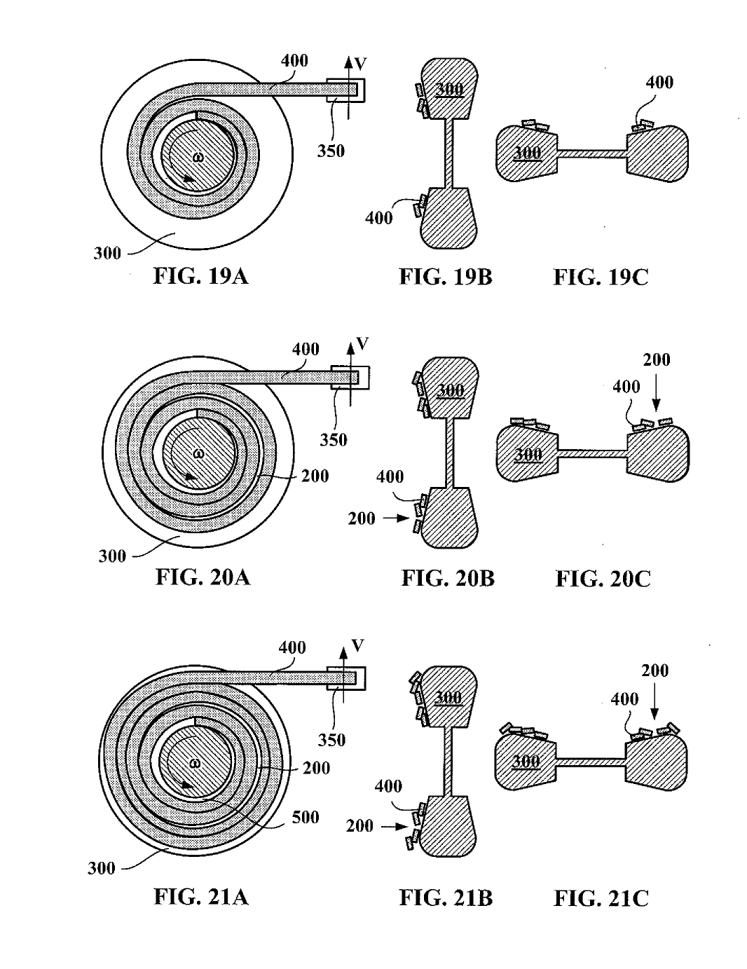

Between the moment shown in FIG. 18A and that shown in FIG. 19A, the operator begins to place the portion of the inner-liner in the zone situated radially between:
the radial position in which, after completion of the tire manufacturing process, the radially outermost annular reinforcement structure will be situated, and
the radial height at which the carcass reinforcement, when the tire, after completion of the tire manufacturing process, is mounted on the rim and inflated to its working pressure, will have its largest axial width.

To obtain a slit in this radial zone, the speed of movement V of the placement tool is increased so that

$${\int }_{0}^{T} V ( t ) \cdot d t > L \qquad ( 6 )$$

Naturally, it would also be possible to keep the speed of movement V constant and reduce the angular speed ψ of the rigid core in order to satisfy this inequality (because T depends on the angular speed ψ), or to combine the two approaches, by modifying both speeds appropriately. To obtain the best productivity, it is however preferable not to reduce the constant angular speed w and to increase the movement speed V.

At the moment represented in FIG. 19A, the formation of the slit has begun. Between this moment and the moment represented in FIG. 20A, the operator again changes the speed of movement V (and/or the angular speed ψ of the rigid core) in order to satisfy the following inequality:

$${\int }_{0}^{T} V ( t ) \cdot d t < L \qquad ( 7 )$$

which again results in an overlap of the portions of strip placed successively.

FIGS. 20A, 20B and 20C indicate the slit 200 which is thus obtained.

Subsequently, the operator continues the placement of the strip in conditions of placement in which the inequality (7) is satisfied.

Therefore, a crescent-shaped slit 200 is obtained in the radial zone mentioned above. In this instance, the slit 200 extends over approximately 300°.

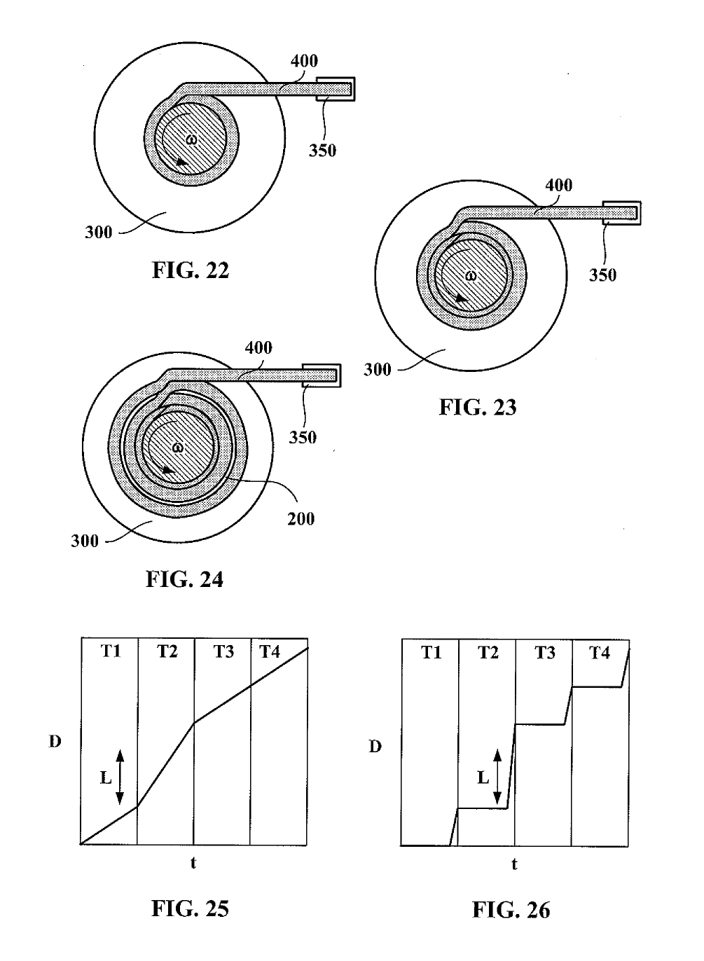

This embodiment of the process according to the invention has the disadvantage that a small portion of the bead, corresponding to the zone 500 of FIG. 21A, is not covered with inner-liner. A second embodiment of the process according to the invention, of which certain steps are represented in FIGS. 22 to 24, makes it possible to overcome this disadvantage.

The starting point is identical to FIG. 17. Unlike the first embodiment, the placement tool does not advance for almost the whole duration of the first revolution. Shortly before completing the revolution, the placement tool is moved in a direction perpendicular to the axis of rotation of the rigid core. In order for there to be overlap, the movement must be less than the width L of the strip. The position represented in FIG. 22 is then reached. The whole portion which will correspond to the bead of the tire is therefore covered with inner-liner.

FIG. 23 represents the situation after a second revolution of the rigid core. Unlike the previous step, the placement tool has been moved by a distance which is greater than the width L of the strip. A beginning of a slit then forms.

The slit 200 appears clearly in FIG. 24 which shows the situation after an additional revolution. Again, the movement of the placement tool at the end of this additional revolution is less than the width L of the strip: the slit 200 is therefore completed.

The rest of the inner-liner is placed while, on each revolution, keeping a movement of the placement tool to less than the width L of the strip.

FIGS. 25 and 26 represent the movement of the placement tool over time, for the two embodiments of the process.

FIG. 25 shows the movement D of the placement tool over time, for the first embodiment of the process according to the invention (FIGS. 18A-21C). The tool advances at a constant speed (periods of rotation of the core T1, T3, T4), except during the revolution corresponding to the initiation of the slit (period of rotation T2), in which the speed is increased, so that the movement of the placement tool during this revolution exceeds the width L of the strip.

FIG. 26 shows the movement D of the placement tool over time, for the second embodiment of the process according to the invention (FIGS. 22-24). The placement tool does not advance, except towards the end of each revolution of the rigid core. For a slit to be created, this movement at the end of a revolution must exceed the width L of the strip to be placed.

Naturally, it is possible to combine the two embodiments of the process according to the invention by providing more complex movements of the rigid core and of the placement tool. Nevertheless, the fundamental principle remains the same: when the zone where it is desired to create a slit is reached, the respective movements of the rigid core and of the placement tool are changed so that, during one revolution of the core, the placement tool advances radially by a distance that is greater than the width of the strip to be placed.

Although it has not been represented, it is also possible to provide a placement beginning radially on the outside of the rigid core and advancing radially towards the inside of the core.

1. A tubeless tire, adapted to be inflated with an inflation gas, comprising:
a crown comprising a crown reinforcement surmounted by a tread;
two sidewalls extending the crown radially inwards;
two beads radially inside the sidewalls and each comprising at least one annular reinforcement structure;
a carcass reinforcement anchored in each of the beads; and
an inner-liner impermeable to the inflation gas, covering the inner surface of the tire;
wherein, in each sidewall of the tire, the inner-liner comprises at least one slit, situated radially between:
(i) the annular reinforcement structure that is radially outermost, and (ii) the radius RE at which the carcass reinforcement, when the tire is fitted to the rim and inflated to its operating pressure, has its largest axial width; and
wherein the slit has a maximum radial height HR of between 0.5 and 5 mm and extends over at least half of the circumference of the tire.

2. The tire according to claim 1, wherein the slit extends over at least three quarters of the circumference of the tire.

3. The tire according to claim 1, wherein the slit extends over the whole circumference of the tire.

4. The tire according to claim 1, wherein the radial height of the slit tends towards zero at its ends.

5. The tire according to claim 1, wherein the slit is continuous.

6. The tire according to claim 1, wherein the slit includes an alignment of holes in the inner-liner.

7. A process for manufacturing a tire according to claim 1, with the inner-liner of the tire being produced by placing a strip of rubber compound, that is gastight to the gas intended for the inflation of the tire, on a rigid core rotated about an axis at a selected angular speed ψ, the strip of width L being placed on the rigid core with the aid of a placement tool, wherein the process comprises the steps of:
moving the placement tool during the placement operation in a direction substantially perpendicular to the axis of rotation of the rigid core at a selected speed of movement v such that, due to the angular speed ψ and the speed of movement V of the placement tool, a portion of the strip placed at the end of a revolution of the rigid core comes into contact with, but does not overlap a portion of the strip placed at the start of the same revolution of the rigid core, or the contact therebetween also involves an overlap; and
momentarily modifying the speed of movement of the placement tool and/or the angular speed of the rigid core so that a portion of the rigid core is not covered by the strip, wherein such speed modification occurs during placement of a portion of the inner-liner that is situated radially between:
a radial position in which, after completion of the tire manufacturing process, the radially outermost annular reinforcement structure will be situated, and
(ii) a radial height at which the carcass reinforcement, when the tire, after completion of the tire manufacturing process, is mounted on the rim and inflated to its working pressure, will have its largest axial width.
